(19) United States
(12) Patent Application Publication
(10) Pub. No.: US 2010/0153489 A1
(43) Pub. Date: Jun. 17, 2010

(54) SERVER DEVICE, CLIENT DEVICE AND CONTROL METHOD AND PROGRAM FOR THE SAME

(75) Inventor: Chieko Ito, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/634,477

(22) Filed: Dec. 9, 2009

(30) Foreign Application Priority Data
Dec. 12, 2008 (JP) 2008-317276

(51) Int. Cl. G06F 15/16

(52) U.S. Cl. 709/203

(57) ABSTRACT

A client device receives a page file containing a link to data from a server device which manages a plurality of data and downloads the data associated with the link from the server device. The client device receives link control information corresponding to the link included in the page file from the server device, determines whether to edit each link included in the page file based on the link control information, edits the link based on determination result, transmits a request for data associated with the link to the server device based on the edited link and the unedited link, updates the link to the page file based on a download destination of the data in the client device, and stores the page file including the updated link.

### BACKGROUND OF THE INVENTION

1. Field of the Invention

The present invention relates to a technique in which a client device is configured to download files via a network from a Web server device.

2. Description of the Related Art

A client device is conventionally connected via the Internet to a Web server device. An HTML file for a Web page is received and displayed on a window of the Web browser. The client device can display the Web page on a monitor offline by storing the HTML file therein. Types of files stored in the client device may be selected. For example, when Windows XP (Registered Trademark) is used, it is possible to select whether to store HTML files including all files (graphics, frame, style, sheet etc.) required to display the Web page or store only the text file(s) to display only the character string of the Web page.

HTML files stored in the above described conventional client device include banners or control buttons associated with link information for connection to other Web pages or other Web server devices. Thus when the client device is offline, information cannot be acquired and operations requesting information are ineffective since the client device cannot connect to other Web pages or other Web server devices according to such link information. Further a Web page may contain advertisements such as limited-time promotional campaigns. When the client device is online, although the Web server device can provide updated advertisements on a provisional basis to the client device, updating is not possible when the client device is offline. Consequently, there is a risk that a user of the client device may view out-of-date unusable information about the promotional campaign and erroneously believe that the campaign is still continuing.

### SUMMARY OF THE INVENTION

The present invention is directed to prevention of erroneous operation and erroneous beliefs by a user caused by information associated with a Web album when a client device displays the Web album offline.

According to an aspect of the present invention, a client device receives a page file containing a link to data from a server device which manages a plurality of data and downloads the data associated with the link from the server device. The client device includes a receiving unit configured to receive link control information corresponding to the link included in the page file from the server device, a determination unit configured to determine whether to edit each link included in the page file based on the link control information, an editing unit configured to edit the link based on determination result, a transmission unit configured to transmit a request for data associated with the link to the server device based on the edited link and the unedited link, an updating unit configured to update the link to the page file based on a download destination of the data in the client device, and a storage unit configured to store the page file including the updated link.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a file download system according to an exemplary embodiment of the present invention.

FIG. 2 is a block diagram illustrating an example of a computer device according to the exemplary embodiment of the present invention.

FIG. 3 is a flowchart illustrating an example of an operation of a client device according to the exemplary embodiment of the present invention.

FIG. 4 illustrates an example of a Web album viewing screen according to the exemplary embodiment of the present invention.

FIG. 5 illustrates an example of a link control information table which stores link control information according to the exemplary embodiment of the present invention.

FIG. 6 illustrates an example of an album viewing screen according to the exemplary embodiment of the present invention.

FIG. 7 is a flowchart illustrating an example of an operation of a Web server device according to the exemplary embodiment of the present invention.

FIG. 8 is a block diagram illustrating an example of a file download system according to an exemplary embodiment of the present invention.

FIG. 9 is a flowchart illustrating an example of an operation of a client device according to the exemplary embodiment of the present invention.

FIG. 10 is a flowchart illustrating an example of an operation of a Web server device according to the exemplary embodiment of the present invention.

### DESCRIPTION OF THE EMBODIMENTS

Various exemplary embodiments, features, and aspects of the invention will be described in detail below with reference to the drawings.

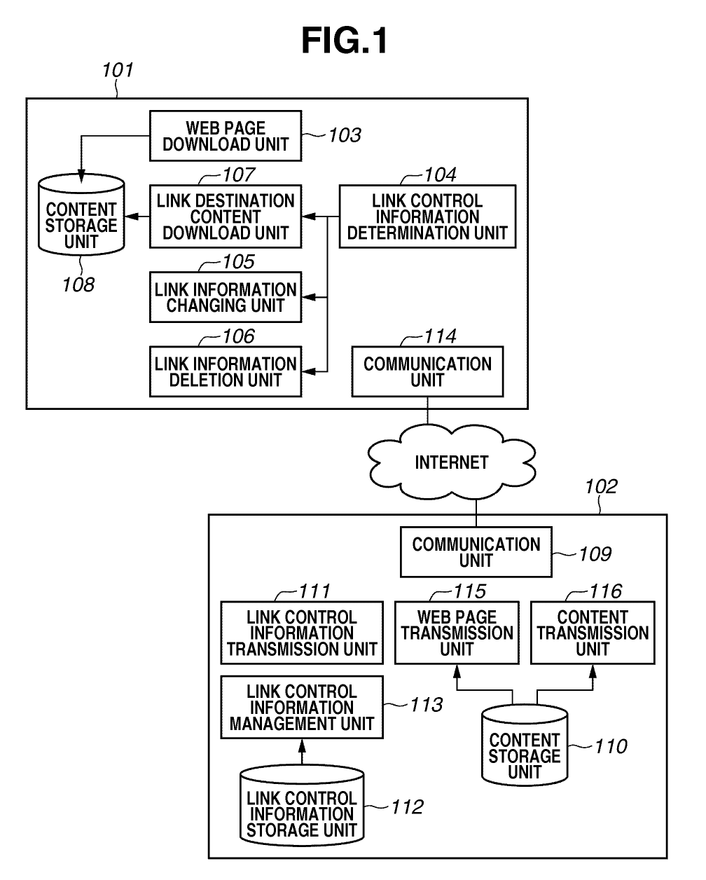

FIG. 1 is a block diagram illustrating an example of a file download system according to a first exemplary embodiment. A client device 101 and a Web server device 102 are connected via a network such as the Internet and communicate various types of information. In the present exemplary embodiment, the client device 101 and the Web server device 102 are respectively realized by a single computer device. However, respective functions may be assigned to a plurality of computer devices as required. When the client device 101 and the Web server device 102 are respectively constituted by a plurality of computer devices, connection using a local area network (LAN) may enable communication between such devices.

The client device 101 includes a Web page download unit 103, a link control information determination unit 104 and a link information changing unit 105. Further a link information deletion unit 106, a link destination content download unit 107, a content storage unit (for client device) 108 and a communication unit 114 (for client device) are provided.

The communication unit 114 acquires various types of information via the Internet from the Web server device 102. The Web page download unit 103 receives HTML files from a desired Web page and stores the files in the content storage unit 108. The Web page download unit 103 is realized by an operation of a network interface 207 or a central processing unit (CPU) 201 described below of the client device 101 in response to a Web browser program pre-installed in the client device 101.

The link determination unit 104 extracts link information from an HTML file received from the Web page download unit 103, receives corresponding link control information from the Web server device 102 and performs determination operations. The link determination unit 104 is realized by the operation of the CPU 201 described below for the client device 101 in response to a plug-in which is pre-installed in the client device 101.

The link destination content download unit 107 downloads content data with reference to the link control information. The link information changing unit 105 changes the links in the HTML files and the link information deletion unit 106 deletes the links. In other words, the link information changing unit 105 and the link information deletion unit 106 serve as a link information editing unit configured to edit the link information based on the link control information. Content data downloaded by the link destination content download unit 107 is stored in a content storage unit 108.

The Web server device 102 includes a communication unit 109 (for the Web server), a content storage unit 110 (for the Web server), a link control information transmission unit 111, a link control information storage unit 112 and a link control information management unit 113.

The communication unit 109 receives a request transmitted from the client device 101 and sends information corresponding to the details of the request to the client device 101. The content storage unit 110 (for the server) stores content data sent to the client device 101. The content data for example is multimedia information including original image files, thumbnail images, background images, text data, HTML files and audio files.

The link control information transmission unit 111 refers to the link control information storage unit 112 and sends the link control information to the client device 101. The link control information management unit 113 performs management operations including registering the link control information in the link control information storage unit 112 and changing or deleting existing link control information.

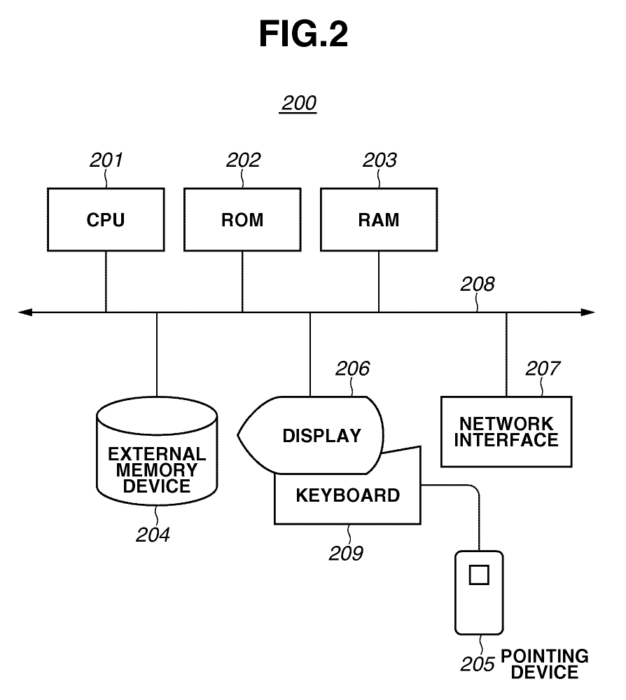

A configuration of the computer device (information processing device) which constitutes the client device or the Web server device in the present exemplary embodiment will be described with reference to the block diagram in FIG. 2. The server device or the client device may be realized respectively by a single computer, or respective functions may be assigned to a plurality of computer devices as required. When a plurality of computer devices constitutes the client device or the Web server device, such devices are communicably connected with each other using the LAN.

In FIG. 2, a central processing unit (CPU) 201 performs overall control of a computer device 200. A read only memory (ROM) 202 stores programs or parameters which do not require variation. A random access memory (RAM) 203 temporarily stores data or programs for example supplied from an external device. An external memory device 204 includes such as a memory card or hard disk which is disposed in and fixed to the computer device 200 or an optical disk, a magnetic or optical card, an IC card or the like which is detachable from the computer device 200.

An interface 205 is an interface with an input device such as a pointing device or keyboard configured to receive operations from a user and input data. An interface 206 is an interface with a display configured to display data supplied from or data stored in the computer device 200. An interface 207 is a network interface configured to connect with a network line such as the Internet. A system bus 208 communicably connects each unit 201 to unit 207.

The external memory device 204 of the computer device which realizes the client device 101 of the present exemplary embodiment stores operating systems (OS), Web browser programs and album display application programs. The external memory device 204 of the computer device which realizes the Web server device 102 of the present exemplary embodiment stores OS and Web application programs.

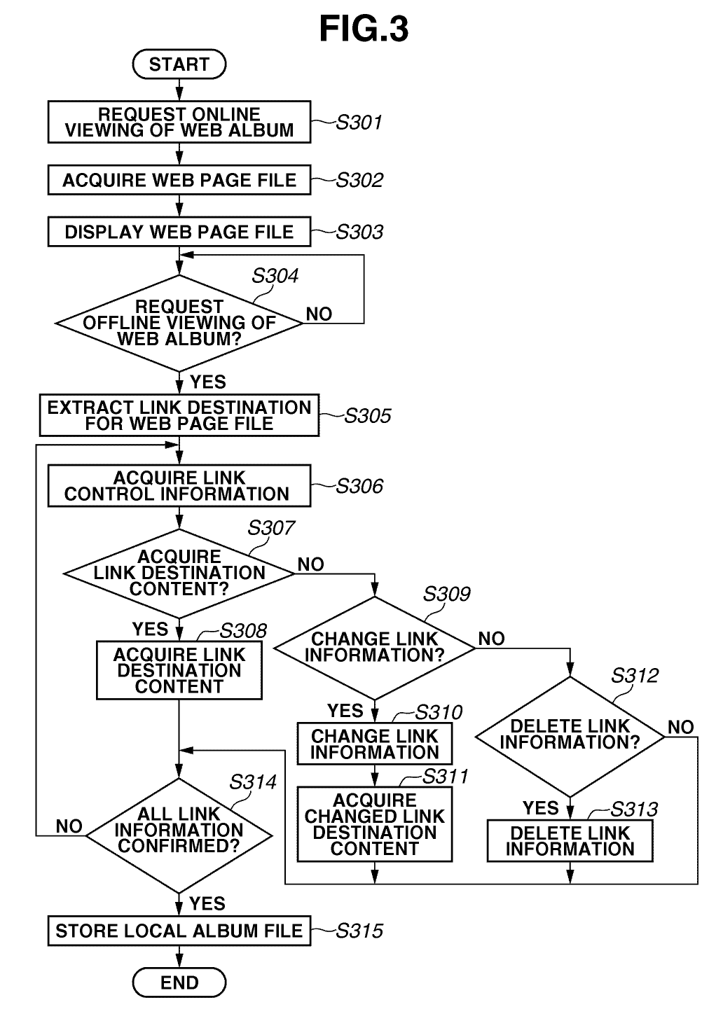

An operation of the client device 101 in the present exemplary embodiment will be described with reference to the flowchart in FIG. 3.

The client device 101 activates a Web browser program in advance, connects to the Web server device 102 via the Internet based on a predetermined URL, sends a password or user ID and receives log-in authentication from the Web server device 102. The client device 101 receives an HTML file for portal screen display from the Web server device 102 and displays the portal screen on a monitor.

In step S301, the client device 101 sends an online-viewing request for online viewing of a Web album to the Web server device 102 according to a menu of the portal screen. In step S302, the client device 101 receives an HTML file (hereafter referred to as “Web page file”) of a Web album, and stores the file in a temporary storage area.

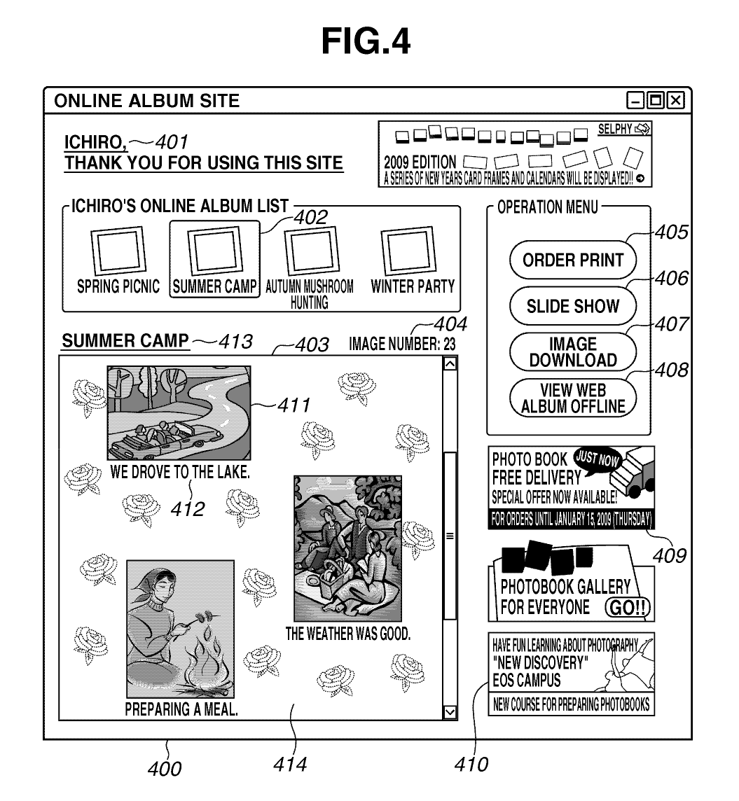

In step S303, the Web page file and the content data which is downloaded according to the link described in the web page file are displayed on the monitor. The Web album viewing screen displayed on the monitor is illustrated in FIG. 4.

FIG. 4 illustrates an example of a Web album viewing screen 400 displayed in a window of a Web browser program. A name of a user 401 who has been authorized login to the client device 101 and a Web album list 402 owned by the user on the Web server device 102 are displayed on the Web album viewing screen 400.

In an album display region 403, a Web album selected from the Web album list 402 is displayed. A thumbnail image 411 of an image file in the Web album and comment information 412 associated with the image file are disposed at a predetermined position and displayed on a background image 414 in the album display region 403. When the thumbnail image 411 is clicked, another screen is opened in which an original image file corresponding to the thumbnail image is read and displayed.

The Web album viewing screen 400 includes a total number of image files 404 in the Web album and a title 413 of the Web album displayed in the album display region 403. A button 405 for ordering printing of the Web album displayed in the album display region 403 via the Internet from a printing services operator is provided.

A button 406 is configured to instruct the Web server device 102 to display the image file in the Web album displayed in the album display region 403 as a slide show. A button 407 is configured to instruct the Web server device 102 to download the original image file in the Web album displayed in the album display region 403 into the client device 101. A button 408 is configured to input a request for offline viewing of the Web album displayed in the album display region 403.

When an advertising banner 409 is clicked, the client device 101 is connected via the Internet with a Web server of the advertising party according to a URL associated with the advertising banner 409 and receives various types of information. When a recommended information banner 410 is clicked, the client device 101 receives new Web page information from the Web server device 102 according to a file path associated with the recommended information banner 410 and acquires recommended information from the operator of the web server device 102.

Thereafter when the client device 101 receives input of an offline-viewing request for offline viewing of the Web album displayed in the album display region 403 (YES in step S304), and the client device 101 sends a request to the Web server device 102.

In step S305, responding to the offline-viewing request of the Web album, the client device 101 reads the Web page file from the temporary storage area, stores the Web page file in the content storage unit 108 and extracts link information from the Web page file. In step S306, the client device 101 receives link control information corresponding to the extracted link information from the Web server device 102.

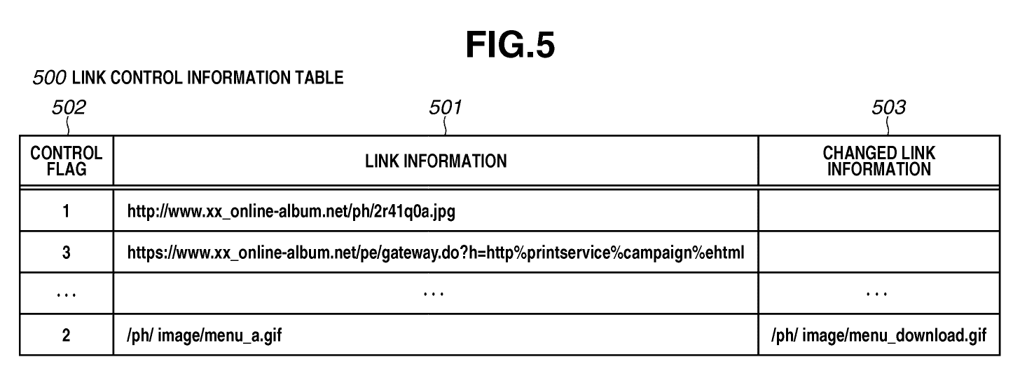

The link control information will be described below with reference to FIG. 5. Link control information includes link information 501 and a control flag 502 indicating a link to content data. The control flag 502 indicates [1] when the content data is downloaded from the link without modification, [2] when the content data is downloaded from a different link, and [3] when no content data is downloaded. Further, changed link information 503 which indicates a link when the control flag is [2] is also included.

A setting of the control flag of the link control information may be performed manually when corresponding content data is stored in the content storage unit 110. Alternately, a plurality of folders associated with each control flag may be prepared in the content storage unit 110 and those control flags may set automatically coinciding with the folder storing the content data.

For example, an advertisement folder is prepared and associated with the control flag [3]. When content data is stored, the control flag for the link control information on the content data is automatically set to [3].

In step S307, the link control information associated with the link described in the Web page file is referred to determine whether there is an instruction for acquisition of the content data for the link described in the Web page file.

When there is an instruction to acquire the content data for the link (YES in step S307), the processing proceeds to step S308. In step S308, the client device 101 requests and downloads the content data for the corresponding link from an external device such as the Web server device 102 and stores the content data in the content storage unit 108.

The content data in this case includes, for example, the original image files corresponding to the thumbnail images 411, image files of the background images 414, or text files for the comment information 412. The comment information 412 is not limited to independent text files and may also include attribute information about original image files.

Alternatively, when there is no instruction for acquisition of the content data for the link described in the Web page file (NO in step S307), the processing proceeds to step S309. In step S309, it is determined whether there is an instruction to change the link described in the Web page file and to acquire the content data for the changed link. If there is the instruction to acquire the content data for the changed link (YES in S309), then in step S310, the client device 101 varies the link information corresponding to the Web page file. Further in step S311, the content data for the changed link information is downloaded by a request to the Web server device 102 and stored in the content storage unit 108.

The content data for example is a Web page associated with the recommended information banner 410. The Web server device 102 prepares different Web pages for online viewing and for offline viewing by the client device 101. In this manner, when a user views an album offline, semi-permanent information can be acquired without the need to acquire the latest information by temporary connecting to the Internet.

If there is no instruction to acquire the content data for the changed link (NO in step S309), then in step S312, it is determined whether there is an instruction to delete the link described in the Web page file. If there is the instruction to delete the link (YES in step S312), in step S313, the client device 101 deletes corresponding link information described in the Web page file.

The content data in this case is the advertising banner 409. In this manner, when a user views an album offline, erroneous viewing of an advertisement for an out-of-date campaign and corresponding misunderstanding can be avoided.

In step S314, the client device 101 determines whether link control information about all link information extracted in step S306 has been confirmed and repeats the processing after step S307 until all link information is confirmed.

In the manner described above, the client device 101 acquires a file path in the content storage unit 108 of the downloaded content data and, updates the link information of the Web page file. In step S315, the updated Web page file is stored as a local album file in the content storage unit 108.

The client device 101 activates the album display application program, reads the local album file from the content storage unit 108 and the content data based on the link information described in the local album file and displays the data on the monitor.

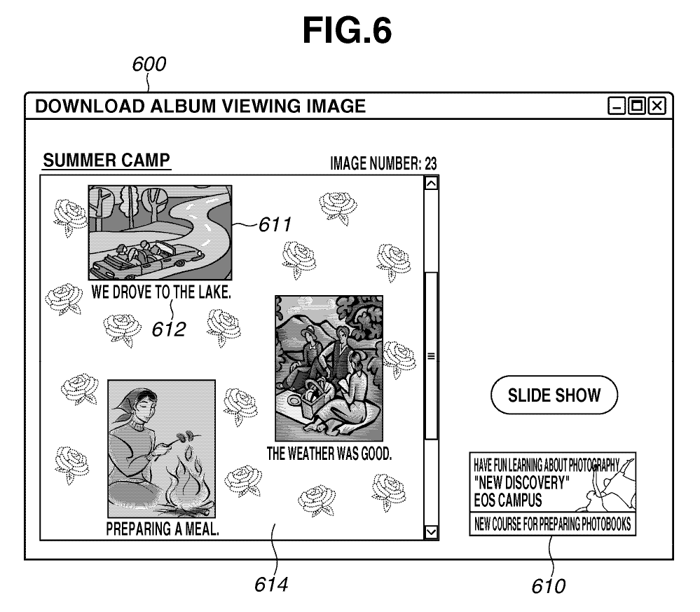

FIG. 6 illustrates an example of an album viewing screen 600 displayed in a window of the album display application program. Similar to the Web album viewing screen 400, a thumbnail image 611 is disposed and laid out on a background image 614 together with comment information 612. However in comparison with the Web album viewing screen 400, an operation menu other than an advertising banner or slideshow required for communication with the Web server device 102 is not present in the album viewing screen 600. Consequently a user can avoid inconveniences including viewing of out-of-date advertisements or failure of processes after performing operating instructions.

On the other hand, an original image file corresponding to the thumbnail images 611 is downloaded, and stored in the content storage unit 108 and a file path thereof is described in the local album file. Thus when the thumbnail image 611 is clicked in the album viewing screen 600 in the same manner as the Web album viewing image 400, the corresponding original image file may be displayed on another screen.

New Web page information corresponding to a recommended information banner 610 is downloaded, and stored in the content storage unit 108, and a file path thereof is described in the local album file. Thus when the recommended information banner 610 is clicked, although the details differ from online viewing, corresponding Web page information is displayed.

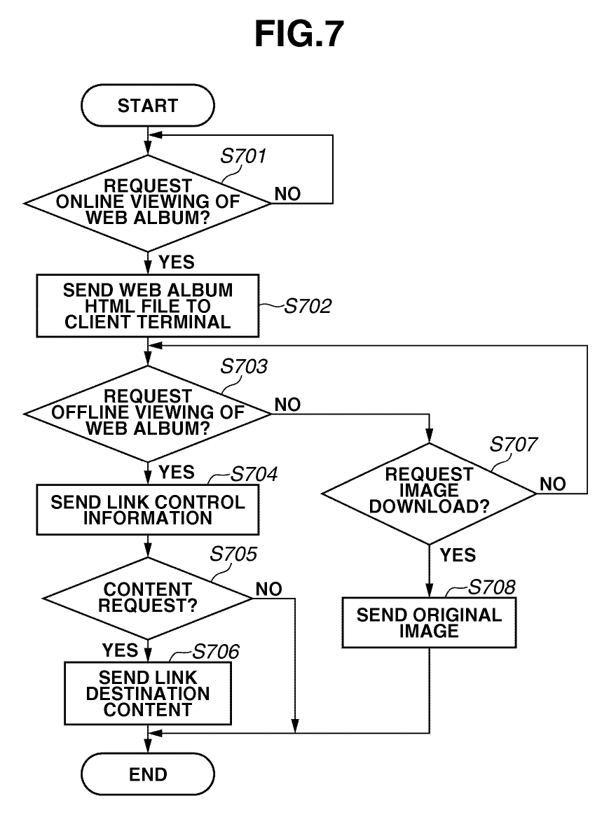

The operation of the Web server device 102 in the present exemplary embodiment will be described below with reference to the flowchart in FIG. 7.

The Web server device 102 authenticates the log-in of the client device 101 in advance, and sends an HTML file for the portal screen display to the client device 101.

In step S701, it is determined whether an online-viewing request for viewing the Web album online has been received from the client device 101. If the Web album viewing request has been received (YES in step S701), then in step S702, the Web server device 102 sends the Web page file to the client device 101.

Then in step S703, the Web server device 102 determines whether the offline viewing request for the Web album displayed on the album display region 403 has been received from the client device 101. If the request is received for offline viewing of the Web album (YES in step S703), in step S704, the Web server device 102 sends the link control information of the Web album displayed on the album display region 403 to the client device 101.

In step S705, the Web server device 102 determines whether a request for content data together with a designation of link information has been received from the client device 101. If the content data request has been received (YES in step S705), then in step S706, the content data corresponding to the received link is read and sent to the client device 101.

When it is determined that the request for the link control information has not been received (NO in step S703), then in step S707, the Web server device 102 determines whether a request for download of the original image file has been received. If the request for download of the original image file has been received (YES in step S707), in step S708, the Web server device 102 reads the original image file associated with the Web album displayed on the album display region 403 and sends the original image file to the client device 101.

In the present exemplary embodiment as described above, firstly the client device receives a Web page file for online viewing from the Web server device, changes or deletes link information thereof based on the link control information, and prepares a new local album file for offline viewing. Then the required content data is downloaded from the Web server device 102 according to the link information.

In other words, according to the present exemplary embodiment, when the client device is viewing an album online, content data can be provided while being updated according to certain timing. On the other hand, when the album is viewed offline, it can switch to provide content data not relevant to the time. Thus the Web server device can provide the client device with optimal content data when viewing online and viewing offline. In addition, a user can be prevented from performing an erroneous operation or misunderstanding resulting from receipt of out-of-date information.

In a second exemplary embodiment, a case will be described in which the Web server device receives a request from the client device, generates a local album file for online viewing which is different from the Web page file for viewing, and provides the generated file to the client device.

Configurations in the present exemplary embodiment which are similar to those in the above described first exemplary embodiment are denoted using the same reference numerals. The details of the configuration characterizing the present exemplary embodiment will be described below and description of those aspects which are overlapped with the first exemplary embodiment will not be provided.

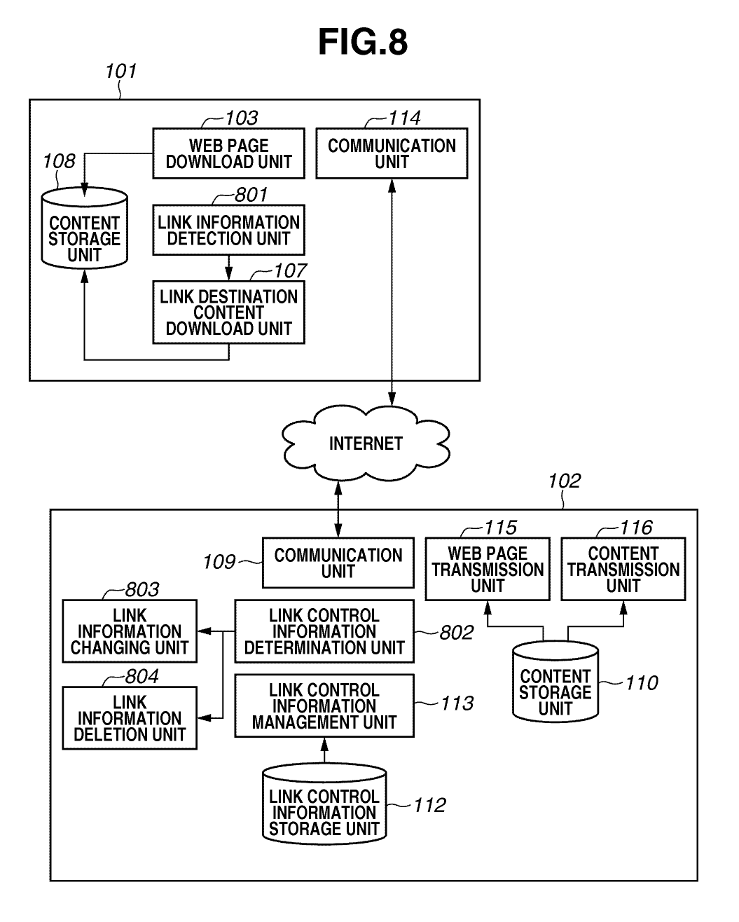

FIG. 8 is a block diagram illustrating an example of a file download system according to the present exemplary embodiment in which the client device 101 and the Web server device 102 are connected by a network and can communicate of various types of information.

In the present exemplary embodiment, the client device 101 and the Web server device 102 are respectively realized by a single computer device. However, respective functions may be assigned to a plurality of computer devices as required. When the client device 101 and the Web server device 102 are respectively constituted by a plurality of computer devices, connection using the LAN may enable communication between such devices.

The client device 101 is provided with a Web page download unit 103, a link information detection unit 801, a link destination content download unit 107, a content storage unit 108 (for client device), and a communication unit 114 (for client device).

The link information detection unit 801 detects link information from a Web page file received from the Web page download unit 103. The link destination content download unit 107 downloads content data based on the detected link information.

The Web server device 102 is provided with a communication unit 109 (for the Web server), a content storage unit 110 (for the Web server) and a link control information storage unit 112. In addition, a link control information management unit 113, a link control information determination unit 802, a link information changing unit 803 and a link information deletion unit 804 are provided.

The link information changing unit 803 and the link information deletion unit 804 serve as a link information editing unit configured to edit the link information based on the link control information.

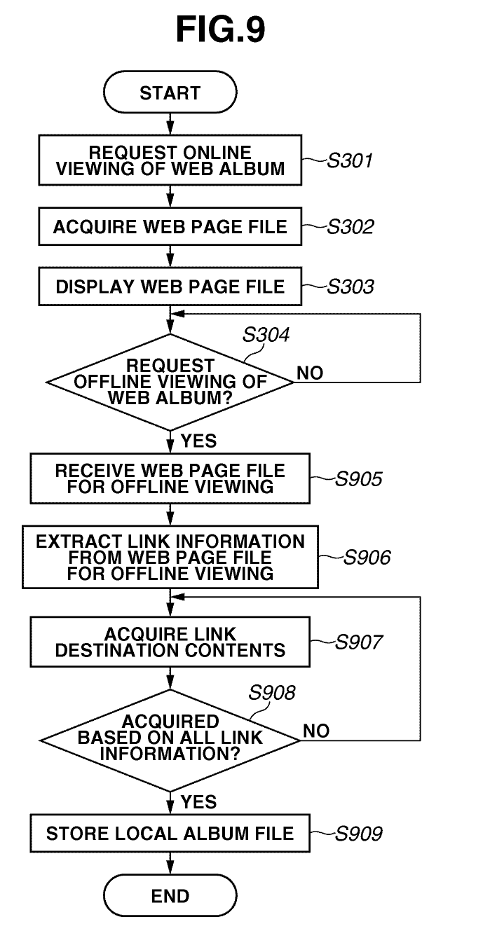

The operation of the client device 101 in the present exemplary embodiment will be described with reference to the flowchart in FIG. 9.

Firstly the client device 101 executes the similar processing as steps S301 to S304 described above. Then in step S905, the client device 101 responds to the offline viewing request for the Web album displayed on the album display region 403 and acquires the Web page file for offline viewing from the Web server device 102.

In step S906, the link information is extracted from the Web page file for offline viewing. Then in step S907, the client device 101 acquires content data from an external device such as the Web server device 102 based on the extracted link information and stores the content data in the content storage unit 108.

In step S908, the client device 101 determines whether the content data corresponding to all link information described in the Web page file has been acquired and repeats the processing in step S906 until the content data for all link information is acquired.

In the manner described above, the client device 101 acquires a file path in the content storage unit 108 for downloaded content data. Then in step S909, the link information of the Web page file received in step S905 by the acquired file path is updated, and a local album file is generated and stored in the content storage unit 108.

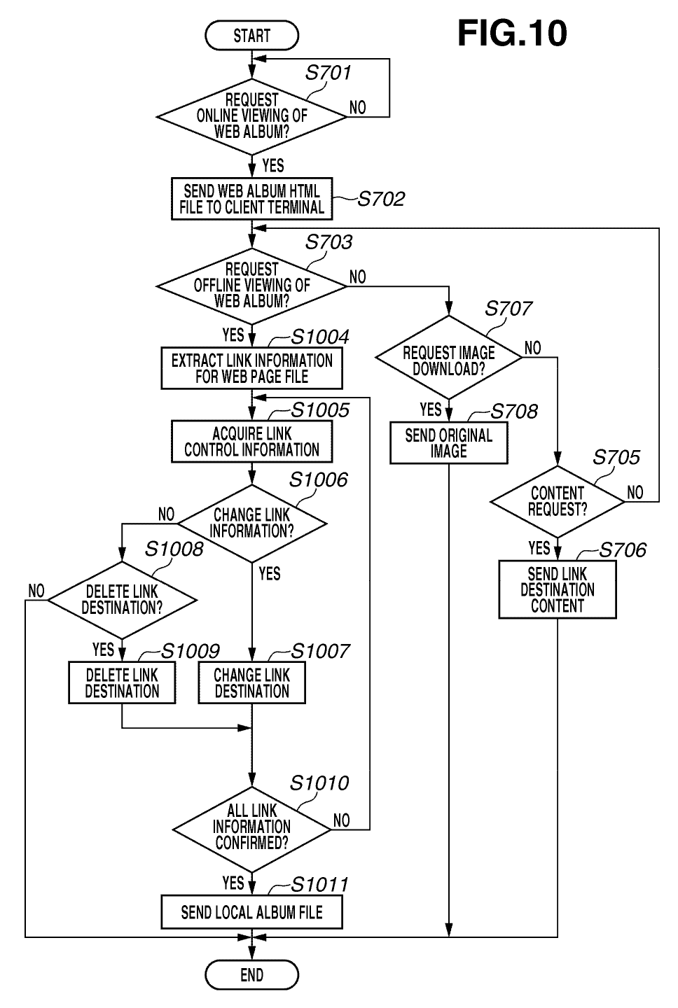

The operation of the Web server device 102 in the present exemplary embodiment will be described below with reference to the flowchart in FIG. 10.

Firstly the Web server device 102 executes the similar processing as steps S701 to S703 described above. In response to the details of a request from the client device 101, the Web server device 102 executes the processing in steps S707 and S708 and steps S705 and 706.

When the Web server device 102 receives an offline-viewing request for a Web album from the client device 101, in step S1004, the Web server device 102 extracts link information about the Web page file displayed on the album display region 403.

In step S1005, the link control information corresponding to the extracted link information is read from the link control information storage unit 112 using the link information management unit 113.

When the link control information is referred to and there is an instruction to change the link described in the Web page file (YES in step S1006), in step S1007, the link information already described in the Web page file is rewritten to link information designated by the link control information.

When the link control information is referred to and there is an instruction to delete the link described in the Web page file (YES in step S1008), in step S1009, the link information described in the Web page file is deleted.

In step S1010, the Web server device 102 determines whether all link information extracted in step S1004 has been confirmed and repeats the processing after step S1005 until all link information is confirmed.

In step S1011, the Web server device 102 sends the Web page file in which the link information has been changed or deleted as described above as a Web page file for downloading to the client device 101.

The client device 101 downloads the content data based on the link information described in the Web page file for downloading. The client device 101 acquires a file path in the content storage unit 108 of the downloaded content data and updates the link information of the downloaded Web page file by using the file path. The updated Web page file for downloading is stored in the content storage unit 108.

In the present exemplary embodiment as described above, the Web server device updates or deletes link information about viewing an album file, generates a new local album file for offline viewing and sends the file to the client device. Then the client device downloads the required content data from the Web server device according to the link information.

Thus, since there is no requirement to install a plug-in or the like in the client device, there is no dependence on the environment of the client device and the present exemplary embodiment can realize the present invention in the similar manner as the first exemplary embodiment and obtain the similar effect.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-317276, filed Dec. 12, 2008, which is hereby incorporated by reference herein in its entirety.

What is claimed is:

1. An apparatus configured as a client device which receives a page file containing a link to data from a server device which manages a plurality of data and downloads the data associated with the link from the server device, the apparatus comprising:
a receiving unit configured to receive link control information corresponding to the link included in the page file from the server device;
a determination unit configured to determine whether to edit each link included in the page file based on the link control information;
an editing unit configured to edit the link based on determination result;
a transmission unit configured to transmit a request for data associated with the link to the server device based on the edited link and the unedited link;
an updating unit configured to update the link to the page file based on a download destination of the data in the client device; and
a storage unit configured to store the page file including the updated link.

2. The apparatus according to claim 1,
wherein the editing unit is configured to change the link associated with first data to a link associated with second data which is different from the first data based on the link control information.

3. The apparatus according to claim 1,
wherein the editing unit is configured to delete the link from the page file based on the link control information.

4. An apparatus configured as a server device which manages a plurality of data, transmits a page file including a link to the data and downloads data associated with the link to a client device in response to a request from the client device based on the link, the apparatus comprising:
a determination unit configured to determine whether to edit each link included in the page file based on link control information upon receiving a predetermined request related to the page file from the client device;
an editing unit configured to edit the link based on the determination result; and
a transmission unit configured to transmit a page file for offline viewing which includes the edited link and the unedited link, to the client device,
wherein the link to the page file for offline viewing is updated based on a download destination of the data in the client device which is associated with the link, and the page file for offline viewing including the updated link is stored in the client device.

5. The apparatus according to claim 4,
wherein the editing unit is configured to change the link associated with first data to a link associated with second data which is different from the first data based on the link control information.

6. The apparatus according to claim 4,
wherein the editing unit is configured to delete the link from the page file based on the link control information.

7. The apparatus according to claim 4, further comprising
a setting unit configured to set the link control information based on a folder which includes data associated with the link.

8. A method for controlling a client device which receives a page file containing a link to data from a server device which manages a plurality of data and downloads the data associated with the link from the server device, the method comprising:
receiving link control information corresponding to the link included in the page file, from the server device;
determining whether to edit each link included in the page file based on the link control information;
editing the link based on the determination result;
transmitting a request for data associated with the link to the server device based on the edited link and the unedited link;
updating the link to the page file based on a download destination of the data in the client device; and
storing the page file including the updated link.

9. A method for controlling a server device which manages a plurality of data, transmits a page file including a link to the data and downloads data associated with the link to a client device in response to a request from the client device based on the link, the method comprising:
determining whether to edit each link included in the page file based on link control information upon receiving a predetermined request related to the page file from the client device;
editing the link based on the determination result; and
transmitting a page file for offline viewing which includes the edited link and the unedited link to the client device,
wherein the link to the page file for offline viewing is updated based on a download destination of the data in the client device which is associated with the link, and the page file for offline viewing including the updated link is stored in the client device.

10. A computer readable storage medium which stores a program to be executed by a computer device that realizes a client device which receives a page file containing a link to data from a server device managing a plurality of data, and downloads the data associated with the link from the server device, the program comprising:
receiving link control information corresponding to the link included in the page file from the server device;
determining whether to edit each link included in the page file based on the link control information;
editing the link based on the determination result;
transmitting a request for data associated with the link to the server device based on the edited link and the unedited link;
updating the link to the page file based on a download destination of the data in the client device; and
storing the page file including the updated link.

11. A computer readable storage medium storing a computer-executable process, the computer-executable process causing a computer device to implement a method for controlling a server device which manages a plurality of data, transmits a page file including a link to the data and downloads data associated with the link to a client device in response to a request from the client device based on the link, the method comprising:
determining whether to edit each link included in the page file based on link control information upon receiving a predetermined request related to the page file from the client device;
editing the link based on the determination result; and
transmitting a page file for offline viewing which includes the edited link and the unedited link, to the client device,
wherein the link to the page file for offline viewing is updated based on a download destination of the data in the client device which is associated with the link and the page file for offline viewing including the updated link is stored in the client device.
